(19) United States
(12) Patent Application Publication
(10) Pub. No.: US 2004/0105000 A1
(43) Pub. Date: Jun. 3, 2004

(54) Microscopic image capture apparatus

(75) Inventor: Kiyoshi Yuri, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olymlpus Corporation, Tokyo (JP)

(21) Appl. No.: 10/723,573

(22) Filed: Nov. 24, 2003

(30) Foreign Application Priority Data
Nov. 29, 2002 (JP) 2002-347602

(51) Int. Cl. H04N 7/18

(52) U.S. Cl. 348/79

(57) ABSTRACT

A microscopic image capture apparatus extracts an area including a sample image from an image obtained by capturing the entire sample, sets a plurality of horizontal positions for acquisition of a height coordinate Z from the extracted sample image area, reads a height coordinate which is a focal point position at the set horizontal position, computes an adjusted position of a focal point in an arbitrary position in the sample image area using the read height coordinate data, and transfers the height of a sample to the adjusted focal position as computed above when the sample is horizontally traveled. The microscopic image capture apparatus extracts an area including a sample image from an image obtained by capturing the entire sample, starts an operation of detecting an autofocus position while a sample image is horizontally traveled when the horizontal travel is directed to a position including a sample image, and stops the operation of detecting an autofocus position when horizontal travel is directed to a position including no sample image.

### CROSS REFERENCE TO RELATED APPLICATION

This application is based upon and claims the benefit of priority from the prior Japanese Application No. 2002-347602, filed Nov. 29, 2002, the entire contents of which are incorporated herein by reference.

### BACKGROUND OF THE INVENTION

1. Field of the Invention

The present invention relates to a microscopic image capture apparatus for forming an image of high precision and wide-angle view by inputting microscopic image information and processing the image information.

2. DESCRIPTION OF THE RELATED ART

Conventionally, there has been a method of observing a microscopic image as a digital image. Normally, when a sample is observed using a microscope, the range of observation at a time depends mainly on the magnification of an objective lens. The higher the magnification of an objective lens, the narrower the range of observation becomes, and the image is only a small portion of the sample. In return, a high precision image can be obtained.

When a microscope is used in pathological diagnostics such as cell diagnostics, tissue diagnostics, etc., it is necessary to grasp the entire sample image to avoid missing a portion to be diagnosed. Furthermore, with the recent rapid progress of information processing technology, there is a strong demand for a high resolution image as in conventional silver-salt film when a microscope-observed image is used in the pathological diagnostics.

In the technology of capturing a microscopic image, there have been various methods developed to form an image of high resolution and wide-angle view. One of the methods is a microscope system for dividing an entire sample image into small sections, capturing a microscopic image of high precision depending on the magnification of each objective lens for each section, fetching the sections with their positions controlled and the overlaps taken into account, producing a composite image by sequentially composing the fetched images by positioning and arranging them, thereby regenerating the entire sample image with high precision and wide-angle view.

In capturing an image for each small section, there arises a displacement of a focal point by an error in the surface precision of a sample stage and the thickness of a sample when the optical axis of an objective lens travels on a small section. Therefore, it is necessary to adjust the displacement of a focal point, and fetch the images of all small sections, thereby requiring a time-consuming process of forming the entire sample image.

To solve the above-mentioned problem, a plurality of focal point positions are manually checked by an observer on a test specimen and the tilt of the test specimen is acquired so that the focal point position can be adjusted in the horizontal travel of a sample stage. In addition to the adjustment to the horizontal travel, an adjustment is also made in the vertical direction, thereby shortening the required time.

Furthermore, to improve the precision of a focal point position, it is necessary to make an adjustment in the vertical direction and then reperforming autofocus processing. When the autofocus processing is reperformed, the position of the autofocus processing is restricted to the point reached by horizontal travel from the previous autofocus processing position by a predetermined distance, thereby reducing the frequency of the autofocus processing, and shortening the time required to obtain an entire image.

### SUMMARY OF THE INVENTION

The microscopic image capture apparatus according to the present invention includes: a sample image area extraction unit for extracting an area including a sample image from an image captured as an entire sample; a height coordinate acquisition position setting unit for automatically setting a plurality of positions in the XY direction in which a height coordinate Z is acquired from the sample image area extracted by the sample image area extraction unit; a coordinate read unit for reading a height coordinate of a focal point position in the position in the XY direction set by the height coordinate acquisition position setting unit; a focal point adjusted position computation unit for computing an adjusted position of a focal point in an arbitrary position in a sample image area using height coordinate data read by the coordinate read unit at the position set by the height coordinate acquisition position setting unit; and a sample travel unit for transferring the height of the sample to an adjusted focal position computed by the focal point adjusted position computation unit when the sample is horizontally traveled.

The microscopic image capture apparatus can also include: a sample image area extraction unit for extracting an area including a sample image from an image captured as an entire sample; and an autofocus unit for automatically detecting a focal point position while performing horizontal travel of a sample. The autofocus unit starts detecting the focal point position during the horizontal travel to the position including a sample image extracted by the sample image area extraction unit, and stops detecting the focal point position during the horizontal travel to a position including no sample image.

Furthermore, the microscopic image capture apparatus forms an entire image of high resolution by dividing into small sections an entire image acquired in a view by capturing the image under low magnification, and capturing the small sections under high magnification. The apparatus includes: a height coordinate acquisition position setting unit for setting a plurality of positions in which a height coordinate is acquired from among grid points including sample images at the grid points of a grid having small sections; a coordinate read unit for reading a height coordinate of a focal point position in horizontal coordinates of a sample under high magnification; and a focal point adjusted position computation unit for computing a height position in an arbitrary position of a small section using height coordinate data read by the coordinate read unit at a grid point set by the height coordinate acquisition position setting unit.

The microscopic image capture apparatus forms an entire image of high resolution by dividing into small sections an entire image acquired in a view by capturing the image under low magnification, and capturing the small sections under high magnification. The apparatus includes: a sample image section extraction unit for extracting a small section including a sample image from among a plurality of small sections; and an autofocus unit for automatically detecting a focal point position when a sample image changes. The autofocus unit starts detecting a focal point position when it horizontally travels to a small section including the sample image extracted by the sample image section extraction unit, and stops detecting the focal point position when it horizontally travels to a small section including no sample image, thereby capturing an image under high magnification.

### BRIEF DESCRIPTION OF THE DRAWINGS

FIG. 1 shows the entire configuration of the microscopic image capture apparatus according to the first embodiment of the present invention;

FIG. 2 shows an example of a display screen displayed on the monitor for use in operating a microscope;

FIG. 3 is a flowchart of the operation in a process performed by the microscopic image capture apparatus according to the first embodiment of the present invention;

FIG. 4 shows the correspondence between a view size in the smallest capture unit and an observing slide, and the basic principle of the capture control method in the present embodiment;

FIG. 5 shows the method of determining a focal point adjustment reference point in acquiring a focal point position for adjustment;

FIG. 6 shows the configuration of the data having the position coordinate (X, Y, Z) of the focal point adjustment reference point recorded in the memory;

FIG. 7 is a flowchart of the operation in a process performed by the microscopic image capture apparatus according to the second embodiment of the present invention;

FIG. 8 shows a practical example of an operation of the process performed by the microscopic image capture apparatus according to the second embodiment of the present invention; and

FIG. 9 is a flowchart of the operation of the process performed by the microscopic image capture apparatus according to the third embodiment of the present invention.

### DESCRIPTION OF THE PREFERRED EMBODIMENTS

First Embodiment

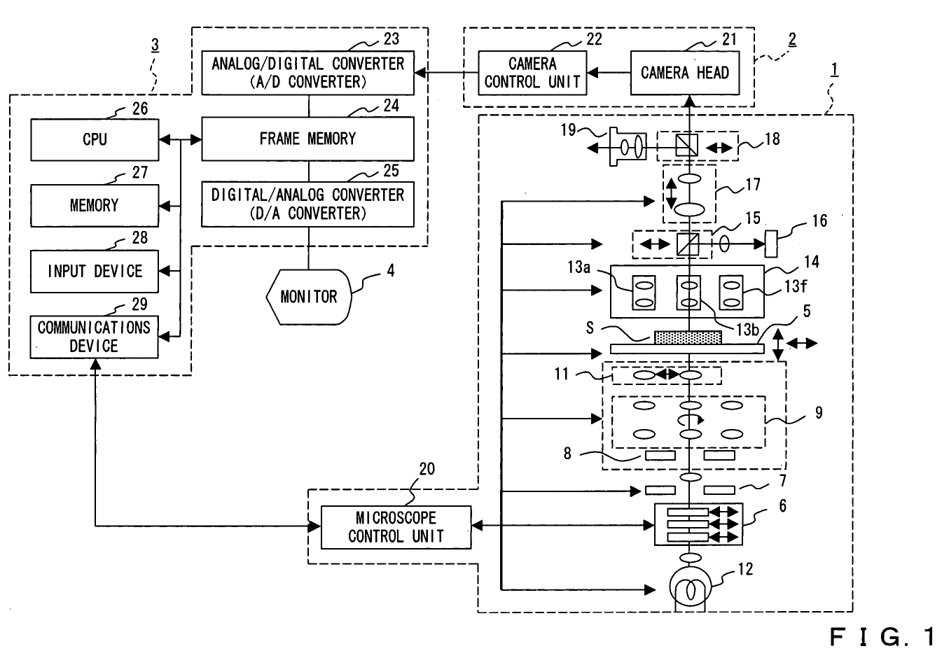

FIG. 1 shows the entire configuration of the microscopic image capture apparatus according to the first embodiment of the present invention. The microscopic image capture apparatus shown in FIG. 1 comprises mainly a microscope unit 1, a camera unit 2, a computer 3, and a monitor 4.

The microscope unit 1 optically retrieves an observing slide image (microscopic image) as an entire image or a small section image under a desired magnification from an observing slide S. In more detail, the above-mentioned microscope unit 1 comprises a sample stage 5 provided with an observing slide S to be observed below which a transmitting filter unit 6, a transmission view diaphragm 7, a transmission aperture diaphragm 8, a condenser optical element unit 9, a condenser top lens unit 11, and a transmission illuminant 12 formed by, for example, a halogen lamp are mounted. Using these components, the observing slide S on the sample stage 5 are illuminated from below.

On the optical axis in the observation optical path over the sample stage 5, a revolver 14 loaded with a plurality of switchable objective lenses 13 (13a through 13f), an autofocus beam splitter 15, a focusing light-receiving element 16, a zoom lens 17, an observation beam splitter 18 for branching an observing slide image, and an eyepiece 19 are arranged. The microscope unit 1 is also provided with a microscope control unit 20 for controlling all the above-mentioned components. In the microscope unit 1 with the configuration above, illuminating light generated by the transmission illuminant 12 is converged by a collector lens, input to the transmitting filter unit 6, and adjusted by the transmitting filter unit 6. The adjusted illuminating light illuminates the observing slide S from below the aperture for illumination in the sample stage 5 through the transmission view diaphragm 7, the transmission aperture diaphragm 8, the condenser optical element unit 9, and the condenser top lens unit 11.

The microscope control unit 20 controls the sample stage 5 for control of the two-dimensional horizontal travel on the plane normal to the optical axis for a change of the observed portion of the observing slide S, and the travel in the optical axis direction for focusing, and also detects coordinates.

The light (observing slide image) transmitted through the observing slide S and converged by the objective lens 13 passes through the autofocus beam splitter 15, the zoom lens 17 for optionally adjusting the magnification for observation, and the observation beam splitter 18, and is directed to a camera head 21 of the camera unit 2 arranged above the eyepiece 19 of the microscope unit 1.

The autofocus beam splitter 15 is removable from an optical path, and a beam of light branched by the autofocus beam splitter 15 is directed by the focusing light-receiving element 16 through an image forming lens, and is used in a metering arithmetic for control of autofocus processing.

The observation beam splitter 18 is also removable from an optical path, and directs a beam passing through an observing slide S to the eyepiece 19 or the camera unit 2.

The camera unit 2 comprises the camera head 21 and a camera control unit 22, and the camera head 21 comprises a solid-state image pickup device formed by, for example, a CMD (charge modulation device) and image forming optics for forming on the CMD an image by the light transmitted through an observing slide S, and converts an observing slide image into an image signal.

The camera control unit 22 controls the camera head 21, and comprises an AGC (auto gain contrast) for automatically adjusting a gain of an incident light quantity to an output voltage. The camera control unit 22 transfers analog image data input from the camera head 21 to an A/D converter 23 of the computer 3.

The computer 3 comprises memory storing a program and control information for various system operations and processes, a CPU 26 for image processing, memory 27 for storing plural pieces of digital image data from frame memory 24 and coordinates data for use in computing a tilt in the vertical direction of a sample, an input device 28 such as a mouse, a keyboard, etc., a communications device 29 for issuing a revolver rotate instruction, a zoom scale instruction, an autofocus control instruction, a sample stage travel instruction, etc., and a capture board. The capture board comprises the A/D converter 23, the frame memory 24, and a D/A converter 25.

The above-mentioned microscope control unit 20 controls each component in the microscope for performing a process in response to each instruction from the communications device 29 of the computer 3.

The A/D converter 23 of the computer 3 digitizes image data fetched by the camera head 21, and transfers the data to the frame memory 24. A part of the digital image data stored in the frame memory 24 is read by the CPU 26 for various processing, and another part of the data is converted into analog data by the D/A converter 25 and displayed on the monitor 4.

The autofocus control function of this system has two autofocus modes, that is, for vertically controlling the traveling of the sample stage depending on the change of a sample image until a terminate command is issued after starting autofocus processing (hereinafter referred to as real time autofocus processing), and for controlling the termination of an autofocus operation when a focusing state is entered after autofocus processing starts (hereinafter referred to as one-shot autofocus processing).

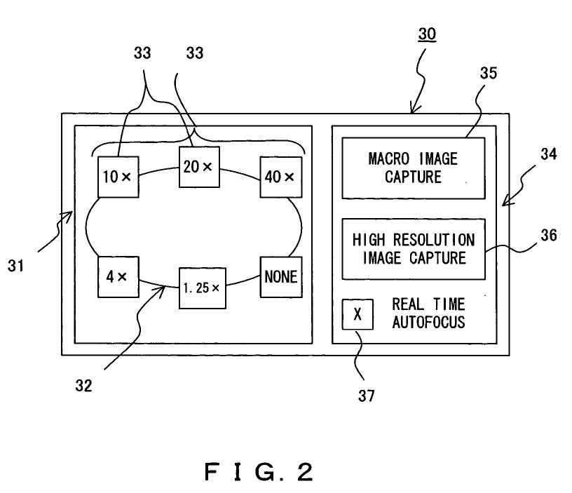

FIG. 2 shows an example of a display screen displayed on the monitor for use in operating a microscope. As shown in FIG. 2, a microscope operation display screen 30 displays an objective lens switch unit 31 on the left. The objective lens switch unit 31 schematically shows a revolver 32 and six lens attachment units 33 for six objective lenses attached around the revolver 32.

The lens attachment units 33 indicate the magnifications of objective lenses, that is, 40×, 20×, 10×, 4×, and 1.25× counterclockwise. In the example shown in FIG. 2, objective lenses of different magnifications are attached, and the sixth six lens attachment unit 33 (“NONE” button) is not loaded with an objective lens.

When an instruction to switch objective lenses is issued, the lens attachment unit 33 of an objective lens of a desired magnification is clicked using the mouse of the input device 28. The operated lens attachment unit 33 enters a button-pressed state, and the magnification of the selected objective lens can be immediately recognized.

On the microscope operation display screen 30, an instruction setting unit 34 for indicating and setting a capturing process is displayed on the right. On the instruction setting unit 34, a “macro image capture” button 35, a “high resolution image fetch” button 36, and a check input window 37 are displayed. To the right of the check input window 37, “real time AF” (autofocus) is displayed.

When an instruction to capture a macro image is issued, the “macro image capture” button 35 is clicked using the mouse for an input. When the instruction is to fetch an image of high resolution, the “high resolution image fetch” button 36 is input. In any case, the input button enters a pressed state.

According to the present embodiment as described above, an “entire image” can be captured using an objective lens of low magnification, or using a macro device whichever can be specified. As shown in FIG. 2, when the mark (x) is displayed in the check input window 37, the real time AF is designated. When the designation of the real time AF is to be released, the check input window 37 is clicked using the mouse, and the display of the mark (x) is turned off, thereby releasing the designation of the real time AF. When the real time AF is designated from the released state of the real time AF, the check input window 37 is clicked using the mouse, and the mark (x) is displayed again to indicate the designation of the real time AF.

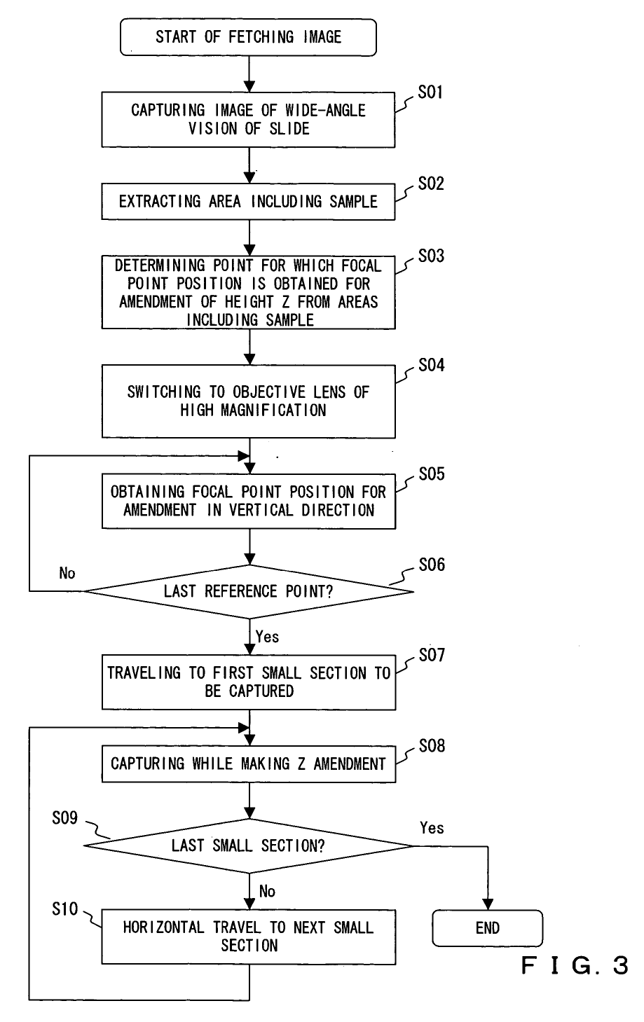

FIG. 3 is a flowchart of the operation in a process performed by the microscopic image capture apparatus with the above-mentioned configuration. In the first embodiment, the smoothness of the position of the focal point on the sample is obtained in advance as position data based on which an adjustment is made to the focal point position during horizontal travel in capturing an image of high magnification.

In FIG. 3, an image of wide-angle view is captured on the entire observing slide S (S01).

In this process, the button of the lens attachment unit 33 to which a desired objective lens of low magnification of the objective lens switch unit 31 is pressed on the microscope operation display screen 30 shown in FIG. 2 (clicked using the mouse as in the cases below), thereby rotating the revolver 14 one turn, and switching into a desired objective lens of low magnification. Then, when the “macro image capture” button 35 is pressed, an image of wide-angle view of the entire observing slide S is captured.

Then, using the captured image of wide-angle view, an area of the sample is extracted on the observing slide S (S02).

The process of extracting an area of the sample can be performed in a method suggested by, for example, Japanese Patent Application Laid-open No. 2000-295462, etc.

In the present embodiment, the captured image of wide-angle view is divided into small sections parallel to the above-mentioned process so that an image of high precision can be captured. To capture an image of high precision, it is necessary to capture an image using an objective lens of high magnification. Therefore, it is necessary to determine the view size of the smallest unit in which an image can be captured using an objective lens of high magnification.

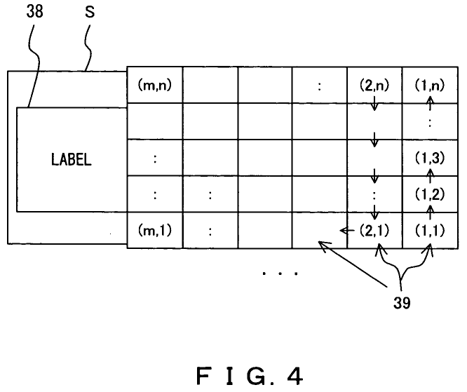

FIG. 4 shows the correspondence between a view size in the smallest capture unit and an observing slide, and the basic principle of the capture control method in the present embodiment.

A small section 39 obtained by vertically and horizontally dividing a capture image area other than the attachment area of a label 38 of the observing slide S shown in FIG. 4 is the view size in the smallest unit in capturing the above-mentioned image of high precision. The view size in the smallest unit is determined by the objective lens 13, the zoom lens 17, and the CCD size of the camera head 21 set when the capturing process is performed.

In the example shown in FIG. 4, an image is divided into m×n small sections from the small section 39 indicated by the coordinates (1, 1) of the lower right corner to the small section 39 at the position indicated by the coordinates (m, n) of the upper left corner. Thus, the capture positions of the m×n small sections 39 of a plurality of positions to be captured on the sample slide S, that is, the positions indicated by the coordinates (1, 1) to the coordinates (m, n), are determined. These small sections 39 are captured using an objective lens of high magnification sequentially as indicated by the arrows shown in FIG. 4.

The capture positions on the sample slide S can be set by providing an overlap area for the small section 39. The setting of the small section 39 and the setting when an overlap area is provided are suggested by Japanese Patent Application Laid-open No. 1997-281405.

Furthermore, the capturing operation can be performed in the order in which the sections are captured horizontally line by line upwards, not vertically line by line toward the left.

Then, in FIG. 3, a focal point adjustment reference point is determined to obtain the focal point position for adjustment in the vertical direction (Z direction) from among the areas including the sample extracted in the process in step S02 (step S03).

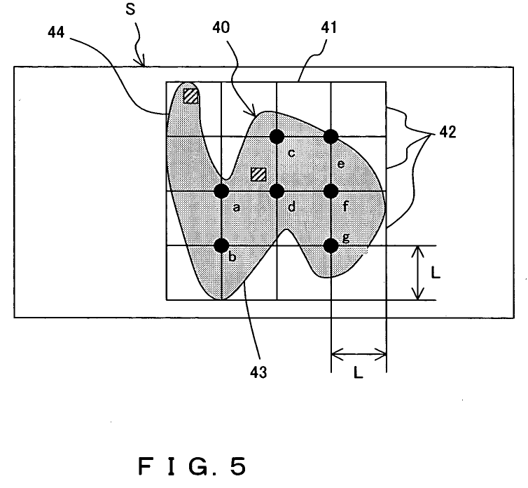

FIG. 5 shows the method of determining a focal point adjustment reference point in acquiring a focal point position for adjustment. Normally, it is necessary that an appropriate distance is reserved between the positions of the reference points for adjustment of a focal point for use in obtaining a focal point position for adjustment in the vertical direction of a sample so that a tilt adjustment can be made to the sample. To attain this, according to the present embodiment, a sample area 41 is set as a bounding rectangle to the sample 40, that is, as a rectangle including the sample 40 on the sample slide S, as shown in FIG. 5. Then, the sample area 41 is divided into small sections 42 at predetermined intervals L.

The small section 42 is set to determine a focal point adjustment reference point, and has nothing to do directly with the small section 39 for determination of the smallest capture unit and the capturing order shown in FIG. 4.

Thus, after setting the small section 42, intersections (a, b, c, . . . , g) of a grid in areas including the sample 40 are defined as focal point adjustment reference points, and the position coordinates (X, Y) of the focal point adjustment reference points are obtained. In this case, if the diview interval L is smaller, a larger number of reference points are set and the precision of the adjustment in the vertical direction (focal point adjustment) is enhanced, but a longer time is required to process the larger number of reference points. Therefore, an appropriate value is set as a diview interval L.

In the example above, the grid point of a small section in an area including a sample is set as a reference point of an acquisition point for height coordinate, but a central point of a small section can be set instead of a grid point, and the point can be set regardless of the position of a small section. In any case, it is necessary that the reference point is set in an area including a sample.

Then, as shown in FIG. 3, an objective lens is switched to an objective lens of high magnification (step S04).

In this process, the revolver 14 shown in FIG. 1 is rotated by pressing the lens attachment unit 33 loaded with a desired objective lens of high magnification from among the lens attachment units 33 displayed in a button form on the microscope operation display screen 30 shown in FIG. 2, and the desired objective lens of high magnification is set on the observing slide S.

Then, the focal point position of the focal point adjustment reference point is obtained for adjustment in the vertical direction as shown in FIG. 3 (step S05).

In this process, to adjust the height position of the image to be captured for each small section 39 and obtain the height of the focal point adjustment reference point set (determined) at the intersection of the grid in the process in step S03, the sample stage 5 shown in FIG. 1 is traveled such that the focal point adjustment reference point can reach the position of the objective lens, and the height coordinate (Z) is obtained as the focal point position of the focal point adjustment reference point (X, Y). The coordinates (Z) can be easily obtained by autofocus processing.

In FIG. 3, it is determined whether or not it is the final focal point adjustment reference point (step S06). If it is not the final focal point adjustment reference point (NO in S06), then control is returned to step S05, and the coordinates (X) of the next focal point adjustment reference point are obtained. This process is repeated until the coordinates of the final focal point adjustment reference point are obtained.

Thus, the height coordinate (Z) of each focal point adjustment reference point is sequentially obtained, the three-dimensional position coordinates (X, Y, Z) including the height of each focal point adjustment reference point are determined, and the data of the determined position coordinates (X, Y, Z) of each focal point adjustment reference point is recorded in the memory 27.

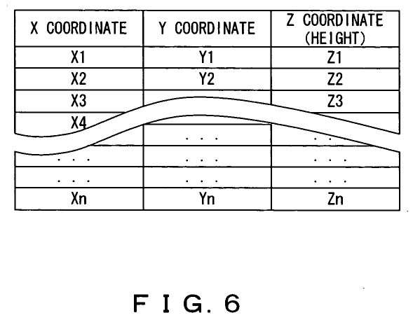

FIG. 6 shows the data configuration of the position coordinate (X, Y, Z) of the focal point adjustment reference point recorded in the memory 27. As shown in FIG. 6, the first to the n-th focal point adjustment reference points set on the intersections of the grid at intervals L are stored in the memory 27.

Described below is the method of adjusting the height (focal point) of the capture position of the sample 40 using the focal point adjustment reference points. In FIG. 5, for example, to know (adjust) the correct height (focal point) of a position 43, a focal point adjustment reference point in the range of “L×2” with the position 43 at the center is detected. At this time, when there are three or more focal point adjustment reference points, the closest three focal point adjustment reference points are detected.

In the example shown in FIG. 5, there are seven focal point adjustment reference points a through g. In this case, the three closest focal point adjustment reference points a, b, and c to the position 43 are selected from among these seven focal point adjustment reference points a through g, and a plane expression including the position coordinates (X, Y, Z) is obtained. Then, by substituting the horizontal position coordinate (X, Y) of the position 43, the height coordinate (Z) of the position 43 is obtained.

When there are only two focal point adjustment reference points, for example, a and b, in the range of the “L×2” with the position 44 as the center as in the case of a position 44 shown in FIG. 5, that is, when there are at most two focal point adjustment reference points, the Z coordinate of the closest focal point adjustment reference point is defined as the height coordinate (Z) of the position 44. In the example shown in FIG. 5, since the focal point adjustment reference point closest to the position 44 is the focal point adjustment reference point a, the Z coordinate of the focal point adjustment reference point a is defined as the height coordinate (Z) of the position 44.

Thus, when all focal point positions (Z coordinates) of the focal point adjustment reference points for adjustment in the vertical direction are acquired, the sample stage 5 is horizontally traveled to the first captured small section 39 (step S07).

The first captured small section 39 is located at the coordinates (1, 1) at the lower right corner shown in FIG. 4. The process after the horizontal travel is automatically performed by the computer 2 shown in FIG. 1 through the microscope control unit 20 when the mark (x) of the check input window 37 for the real time AF (autofocus) is released on the microscope operation display screen 30 shown in FIG. 2, and the “high resolution image fetch” button 36 is input.

After the process above, the small section 39 is captured while making an adjustment to the Z coordinate (step S08).

In this process, the small section 39 at the first coordinates (1, 1) does not include the sample 40 in the example shown in FIG. 5. In this case, the adjustment to the Z coordinate is substantially “0”.

Then, it is determined whether or not the current small section is the last small section 39 at the coordinates (m, n) (step S09).

If the small section is not the last small section 39 (NO in S09), then there is the small section 39 to be captured next, the sample stage 5 is horizontally traveled to the next small section 39 (step S10), control is returned to step S8, the small section 39 to which the sample stage 5 horizontally traveled is captured while making an adjustment to the Z coordinate of the section, and the determination in step S9 is made. This process is repeated until the last small section 39 is captured (YES in S09).

Thus, the small section 39 at the first coordinates (1, 1) through the small section 39 at the last coordinates (m, n) are sequentially captured. For the small section 39 including the sample 40, the sample stage 5 horizontally travels through it, and the position in the vertical direction is adjusted based on the focal point adjustment reference point, thereby capturing an image of high precision and in focus with the focal point of the sample 40 adjusted.

As described above, according to the first embodiment of the present invention, the sample image area on the sample slide is extracted some points in the sample image area are selected as focal point adjustment reference points, and a series of processes of obtaining the tilt of the sample by detecting the focal point position at the reference point can be automatically performed, thereby improving the operability of the microscope when a microscopic image is captured.

According to the present embodiment, it is not necessary to perform a manual operation of obtaining the tilt of a sample as a preparation for the observation of the sample. Furthermore, since the position at which the height data of the sample is acquired is set in the area including the sample, an error occurring by performing autofocus in an area including no sample when the autofocus processing is performed to obtaining height information can be avoided.

Second Embodiment

When the sample 40 has small concave and convex portions on its surface or when samples are not gathered but are scattered as shown in FIG. 5, the focal point position can be obtained with high precision only by making an adjustment in the vertical direction using the adjustment to the Z coordinates of the reference points at predetermined intervals. According to the present invention, a practical sample image can be regenerated by obtaining correct focus in the real time autofocus processing depending on a change in the state of the captured surface during the travel through each small section in the above-mentioned case. This process is described below as the second embodiment of the present invention.

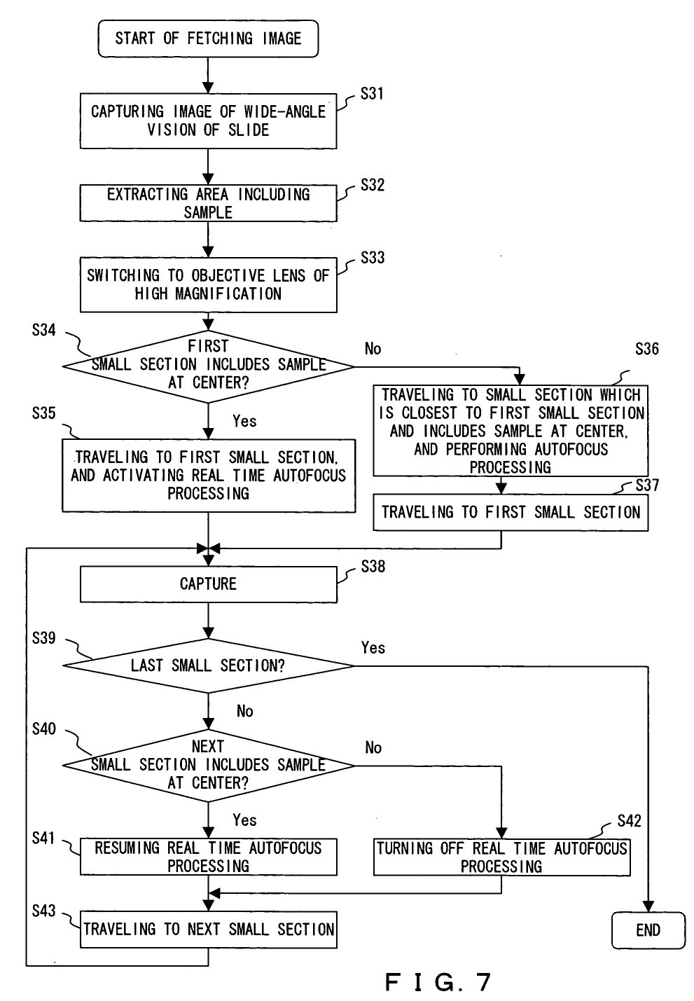

FIG. 7 is a flowchart of the operation of the process performed by the microscopic image capture apparatus according to the second embodiment of the present invention. The hardware configuration of the microscopic image capture apparatus in the present embodiment and the configuration of the microscope operation display screen are respectively the same as the hardware configuration shown in FIG. 1 and the configuration of the display screen shown in FIG. 2.

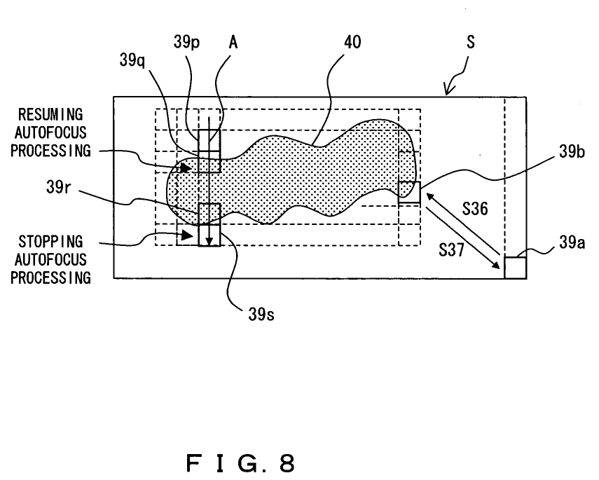

FIG. 8 shows a practical example of an operation performed in the above-mentioned process.

In FIG. 7, the process (step S31) of capturing an image of wide-angle view of the observing slide S using an objective lens of low magnification, and the process (step S32) of extracting an area including a sample image are the same as those in step S01 and step S02 shown in FIG. 3. In FIG. 7, the process (step S33) of switching to an objective lens of high magnification is the same as the process in step S04 shown in FIG. 3.

Then, as shown in FIG. 7, it is determined whether or not there is a sample at the center of the first captured small section (for example, the small section 39 in the position indicated by the first coordinates (1, 1) shown in FIG. 4) (step S34).

If there is a sample (YES in S34), then the sample stage 5 horizontally travels to the first small section 39, and the real time autofocus processing is activated (step S35).

If there is no sample (NO in S34), the small section 39 which is closest to the first small section 39 and has a sample at the center is obtained based on the area which includes a sample and extracted in step S32, the sample stage 5 travels to the obtained small section 39, the one-shot autofocus processing is performed to obtain a focal point position (refer to step S36, and the arrow S36 shown in FIG. 8), and the sample stage 5 travels to the first small section 39 (refer to step S37, and the arrow S37 shown in FIG. 8).

In a series of processes in steps S36 and S37, the autofocus processing is performed on the central point of the captured view. Therefore, if there is no sample at the center of the first small section 39a in FIG. 8, then there occurs a fault of stopping the operation of the entire apparatus by an error occurring when the real time autofocus processing is activated.

Therefore, to avoid the fault, a proviewal Z coordinate is set for the first small section 39a. The proviewal Z coordinate is obtained from the small section 39b which is the closest to the first small section 39a and has a sample at the center. Thus, although the first small section 39a having no sample is captured, it is captured based on the set proviewal Z coordinate. As a result, no error is derived.

As described above, when the first small section 39a is captured, the real time autofocus processing is activated when it includes a sample, and a proviewal Z coordinate is set when it includes no sample.

Then, the small section 39 can be captured with high resolution (step S38).

Continuously, it is determined whether or not the captured small section 39 is the last small section 39 (step S39).

That is, it is the process to check whether or not there is the small section 39 to be captured next. If it is determined that the section is not the last small section 39, that is, there is the small section 39 to be captured next (NO in S39), then it is determined whether or not there is a sample at the center of the small section 39 (step S40).

If there is a sample at the center of the small section 39 (YES in S40), then the real time autofocus processing is activated (step S41), and the sample stage 5 travels to the next small section (step S43). If there is no sample in the small section 39 (NO in S40), then activation of the real time autofocus processing is stopped (step S42), and the sample stage 5 travels to the next small section (step S43). Back to the process in step S38, the processes in steps S38 through S43 are repeated. Thus, in the process in step S39, the small sections 39 are continuously captured with high resolution until it is determined that the captured small section 39 is the last small section 39.

By referring to FIG. 8, the relationship between the presence/absence of a sample at the center of the small section 39 and the activation and stop of the real time autofocus processing is described below. Assume that the process of capturing the small section 39 with high resolution has proceeded up to the small section 39p as indicated by the arrow A as shown in FIG. 8. Since there is no sample at the center of the small section from the upper small section to the small section 39p, the real time autofocus processing is stopped.

When the sample stage 5 travels to the small section 39q which includes a sample at the center, the activation of the real time autofocus processing is resumed, and the similar status continues up to the small section 39r.

When the sample stage 5 travels to the next small section 39s which includes no sample at the center, the activation of the real time autofocus processing is stopped. The status continues until the capturing surface reaches the position of a small section including a sample at the center.

Thus, while repeating resuming and stopping the activation of the real time autofocus processing, the high resolution image capturing process is continued from the first small section 39a to the last small section 39 in the position indicated by the coordinates (m, n).

According to the second embodiment, although a sample has an uneven surface or samples are scattered, the activation of the real time autofocus processing can be freely switched between the stopped state and the resuming state depending on the presence/absence of a sample with the process activated. Therefore, the time required to enter the correct focus state can be shortened, and the time required to enter the state of fetching an image from traveling to small sections can also be shortened.

Since the target range of the autofocus processing is reduced after the autofocus processing or the proviewal focal point position is set at the first small section and the capturing operation is performed, and the central position of the small section obtained in the autofocus processing is defined as an adjusted position in the vertical direction, the correct focus can be obtained sooner, and the obtained position does not largely deviate from the actual focal point position although autofocus error occurs due to insufficient contrast, thereby avoiding an undesired out-of-focus image.

As described above, since the microscopic image capture apparatus according to the present invention first obtains the horizontal travel position and the height position of a sample, and then simultaneously performs horizontal travel and makes an adjustment in the vertical direction, it is not necessary to manually perform an operation of obtaining the tilt of the sample as in the conventional method, thereby improving the operation efficiency.

According to the present embodiment, it is not necessary to perform a manual operation of obtaining the tilt of a sample as a preparation for the observation of the sample. Furthermore, since the autofocus processing is continuously performed while performing horizontal travel on the sample (real time autofocus processing), it is not necessary to suspend the autofocus processing until the horizontal travel and the vertical travel are completed but the autofocus processing can be continuously performed when the next small section is processed, thereby improving the precision in focus and the efficiency in a capturing operation.

In this case, if it is determined that the sample stage has traveled to an area including no sample according to the sample presence/absence information, the autofocus processing is automatically suspended. Therefore, the capturing operation can be protected against an interrupt due to an AF error during the continuous autofocus processing. It is desired that the presence/absence of a sample is determined around the center of a small section to be captured so that the autofocus processing can be interrupted on the small sections including a sample only at the periphery and no sample at the center. Thus, the occurrence of an AF error can be perfectly suppressed.

Third Embodiment

Since the status of a sample depends on various conditions, it is convenient if an adjustment using a focal point adjustment reference point or the real time autofocus processing can be selected in the horizontal travel to a small section depending on the status of the sample. This is explained below as the third embodiment of the present invention.

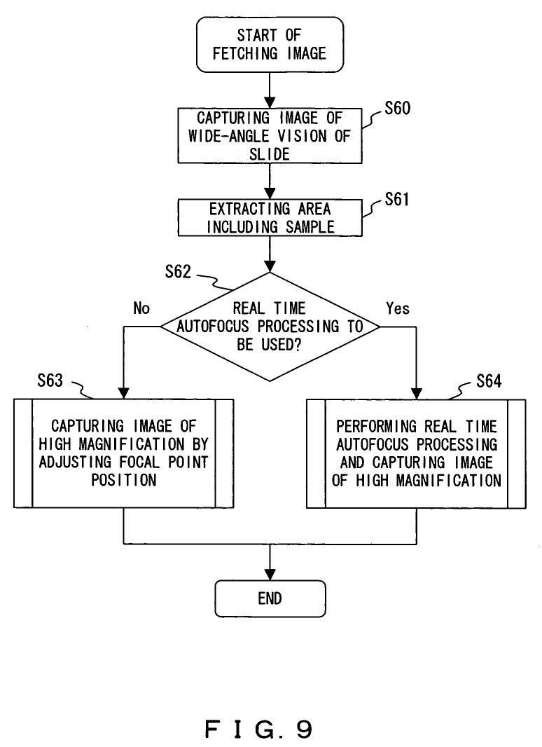

FIG. 9 is a flowchart of the operation of the process performed by the microscopic image capture apparatus according to the third embodiment of the present invention. The hardware configuration of the microscopic image capture apparatus and the configuration of the microscope operation display screen of the monitor according to the present embodiment are respectively the same as the hardware configuration shown in FIG. 1 and the configuration of the display screen shown in FIG. 2.

In FIG. 9, the process of capturing an image of wide-angle view of the entire observing slide S using an objective lens of low magnification (step S60) and the process of extracting an area including a sample image (step S61) are the same as the processes in step S01 and S02 shown in FIG. 3.

Then, the observer of a microscopic image determines the status of the sample from the image of wide-angle view of the entire observing slide S displayed on the monitor 4, and selects whether or not the real time autofocus processing is to be performed (step S62).

In this selection, for example, when a sample has concave and convex portions on its surface, or when samples are scattered in the view, the real time autofocus processing is recommended. When a sample has a smooth surface and spreads over the entire view, the real time autofocus processing is not recommended.

In this case, whether samples are scattered or spread over the view can be determined according to the presence/absence of information about the sample image extracted in the sample area extracting process. Therefore, the above-mentioned process in S62 can be automatically performed based on the result of the sample area extracting process.

When the real time autofocus processing is not performed (NO in S62), the “high resolution image fetch” button 36 is pressed with the mark (x) turned off in the check input window 37 displayed on the left of the “real time autofocus processing” on the microscope operation display screen 30 shown in FIG. 2.

Thus, the process of capturing an image of high magnification by an adjustment of the focal point position is performed (step S63).

The process of capturing an image of high magnification without performing the real time autofocus processing is the same as the processes in steps S04 through S09 shown in FIG. 3.

On the other hand, when the real time autofocus processing is performed (YES in S62), the “high resolution image fetch” button 36 is pressed with the mark (x) indicated in the check input window 37 displayed on the left of the “real time autofocus processing” on the microscope operation display screen 30 shown in FIG. 2.

Thus, the process of capturing an image of high magnification while performing the real time autofocus processing is executed (step S64).

The process of capturing an image of high magnification while performing the real time autofocus processing is the same as the processes in steps S33 through S41 shown in FIG. 7.

As described above, according to the third embodiment of the present invention, a user can select a method of fetching an image of high magnification by checking an image of wide-angle view of low magnification before actually fetching an image of high magnification. Therefore, the operability of a microscope device can be improved when a microscopic image is captured.

In each embodiment, an image of wide-angle view of the entire sample is sequentially captured using an objective lens of low magnification, but a macro device capable of collectively capturing the entire sample can be mounted to collectively capture the entire image using the macro device.

What is claimed is:

1. A microscopic image capture apparatus, comprising:
a sample image area extraction unit extracting an area including a sample image from an image captured as an entire sample;
a height coordinate acquisition position setting unit automatically setting a plurality of positions in an XY direction in which a height coordinate Z is acquired from a sample image area extracted by said sample image area extraction unit;
a coordinate read unit reading a height coordinate of a focal point position in the position in the XY direction set by said height coordinate acquisition position setting unit;
a focal point adjusted position computation unit computing an adjusted position of a focal point in an arbitrary position in a sample image area using height coordinate data read by said coordinate read unit at the position set by said height coordinate acquisition position setting unit; and
a sample travel unit transferring a height of a sample to an adjusted focal position computed by a focal point adjusted position computation unit when the sample is horizontally traveled.

2. The apparatus according to claim 1, wherein said coordinate read unit performs autofocus processing with a sample horizontally traveled to a set position, and reads a height position of said sample travel unit after completion of autofocus processing as a height coordinate.

3. The apparatus according to claim 1, wherein said height coordinate acquisition position setting unit sets a position of a grid point including a sample image in grid points of sections obtained by dividing a sample image area at predetermined intervals in grid form as a position in which a height coordinate is obtained.

4. A microscopic image capture apparatus, comprising:
a sample image area extraction unit extracting an area including a sample image from an image captured as an entire sample; and
an autofocus unit automatically detecting a focal point position while performing horizontal travel of a sample, wherein
said autofocus unit starts detecting the focal point position during horizontal travel to a position including a sample image extracted by said sample image area extraction unit, and stops detecting a focal point position during horizontal travel to a position including no sample image.

5. A microscopic image capture apparatus which forms an entire image of high resolution by dividing into small sections an entire image of a sample captured under low magnification, and capturing the small sections under high magnification, comprising:
a height coordinate acquisition position setting unit setting a plurality of positions in which a height coordinate is acquired from among grid points including sample images at grid points of a grid having small sections;
a coordinate read unit reading a height coordinate of a focal point position in horizontal coordinates of a sample under high magnification; and
a focal point adjusted position computation unit computing a height position in an arbitrary position of a small section using height coordinate data read by said coordinate read unit at a grid point set by said height coordinate acquisition position setting unit.

6. A microscopic image capture apparatus which forms an entire image of high resolution by dividing into small sections an entire image captured under low magnification, and capturing the small sections under high magnification, comprising:
a sample image section extraction unit extracting a small section including a sample image from among a plurality of small sections; and
an autofocus unit automatically detecting a focal point position when a sample image changes, wherein
said autofocus unit starts detecting a focal point position when said unit horizontally travels to a small section including the sample image extracted by said sample image section extraction unit, and stops detecting a focal point position when said unit horizontally travels to a small section including no sample image, thereby capturing an image under high magnification.

7. The apparatus according to claim 6, wherein
when a first small section has no sample at a center, said autofocus unit travels to a small section which is closest to the first small section and has a sample at a center, and performs autofocus processing.

8. A focal point position adjusting method for use with a microscopic image capture apparatus, comprising:
extracting an area including a sample image from an image captured as an entire sample;
starting an automatic operation of detecting a focal point position with horizontal travel of a sample when horizontal travel is performed to a position including an extracted sample image; and
stopping an automatic operation of detecting a focal point position when horizontal travel is performed to a position including no sample image.

9. A microscopic image capturing method for use with a microscopic image capture apparatus, comprising:
extracting an area including a sample image from an image captured as an entire sample;
setting a plurality of horizontal positions in which a height coordinate Z is acquired from an extracted sample image area;
reading a height coordinate which is a focal point position in the set horizontal position;
computing an adjusted position of a focal point in an arbitrary position in a sample image area using the set horizontal position and height coordinate data read in the horizontal position; and
transferring a height of a sample to the computed adjusted focal position when a sample is horizontally traveled.

10. A microscopic image capturing method, comprising:
capturing an image of wide-angle view of the entire observing slide,
extracting an area including a sample image from the image of wide-angle view;
capturing an image of high magnification while adjusting a focal point position by setting real time autofocus processing to be used when it is determined that a sample has a concave and convex surface or samples are scattered in a view according to the presence/absence of information about a sample image obtained in a process of extracting the area including the sample image; and
capturing an image of high magnification by setting real time autofocus processing not to be used when it is determined that a sample has a smooth surface and spreads a view according to the presence/absence of information about a sample image obtained in a process of extracting the area including the sample image.

11. The method according to claim 10, wherein
when the real time autofocus processing is set to be used, an image of high magnification is captured while a focal point position is adjusted in the focal point position adjusting method according to claim 8, and when the real time autofocus processing is set not to be used, an image of high magnification is captured while a focal point position is adjusted in the focal point position adjusting method according to claim 9.
